(19) United States
(12) Patent Application Publication
(10) Pub. No.: US 2014/0179348 A1
(43) Pub. Date: Jun. 26, 2014

(54) SYSTEM AND METHOD FOR DETERMINING WHEN SMARTPHONE IS IN VEHICLE

(71) Applicant: Sascha Simon, Warwick, NY (US)

(72) Inventor: Sascha Simon, Warwick, NY (US)

(21) Appl. No.: 14/095,156

(22) Filed: Dec. 3, 2013

Related U.S. Application Data
(63) Continuation-in-part of application No. 14/072,231, filed on Nov. 5, 2013.
(60) Provisional application No. 61/740,814, filed on Dec. 21, 2012.
(60) Provisional application No. 61/740,831, filed on Dec. 21, 2012.
(60) Provisional application No. 61/740,851, filed on Dec. 21, 2012.
(60) Provisional application No. 61/745,677, filed on Dec. 24, 2012.

(51) Int. Cl. H04W 4/02; H04W 4/04

(52) U.S. Cl. CPC H04W 4/027; H04W 4/046
USPC 455/456.1

(57) ABSTRACT

A device includes a parameter detector, an input component, an accessing component, a comparator and an identifier. The parameter detector detects a first parameter and a second parameter and can generate a detected parameter signature based on the first detected parameter and the second detected parameter. The input component can input the detected parameter signature into a database. The accessing component can access the detected parameter signature from the database. The comparator can generate a comparison signal. The identifier can identify a location based on the comparison signal. The parameter detector can further detect a third parameter and a fourth parameter and can generate a second detected parameter signature based on the third detected parameter and the fourth detected parameter. The comparator can generate the comparison signal based on the detected parameter signature and the second detected parameter signature.

The present application claims priority from: U.S. Provisional Application No. 61/740,814 filed Dec. 21, 2012; U.S. Provisional Application No. 61/740,831 filed Dec. 21, 2012; U.S. Provisional Application No. 61/740,851 filed Dec. 21, 2012; and U.S. Provisional Application No. 61/745,677 filed Dec. 24, 2012, the entire disclosures of which are incorporated herein by reference. The present application is a continuation-in-part of U.S. application Ser. No. 14/072,231 filed Nov. 5, 2013, the entire disclosure of which is incorporated herein by reference.

### TECHNICAL FIELD

Various embodiments described herein relate generally to methods and apparatus utilizing the output of sensors and other functionality embedded in smartphones and, more particularly, to methods and apparatus for determining the identity, the type and class of vehicle a Smartphone is in.

### BACKGROUND

Vehicle telematics is the technology of sending, receiving and storing information to and from vehicles and is generally present (at least to a limited extent) in the automotive marketplace today. For example, both General Motors (through their OnStar offering) and Mercedes Benz (through their Tele-Aid and more recent mbrace system offering) have long offered connected-vehicle functionality to their customers. Both of these offerings make use of the data available on a vehicle's CAN bus, which is specified in the OBD-II vehicle diagnostics standard. For example, the deployment of an airbag, which suggests that the vehicle has been involved in a crash, may be detected by monitoring the CAN bus. In this event, a digital wireless telephony module that is embedded in the vehicle and connected to the vehicle's audio system (i.e., having voice connectivity) can initiate a phone call to a telematics service provider (TSP) to “report” the crash. Vehicle location may also be provided to the TSP using the vehicle's GPS functionality. Once the call is established, the TSP representative may attempt to communicate with the vehicle driver, using the vehicle's audio system, to assess the severity of the situation. Assistance may thus be dispatched by the TSP representative to the vehicle as appropriate.

Historically, these services were focused entirely on driver and passenger safety. These types of services have expanded since their initial roll-out, however, and now offer additional features to the driver, such as concierge services. The services, however, remain mainly focused on voice based driver to call center communication, with data services being only slowly introduced, hindered by low bandwidth communication modules, high cost and only partial availability on some model lines.

As a result, while generally functional, vehicle telematics services have experienced only limited commercial acceptance in the marketplace. There are several reasons for this. In addition to low speeds and bandwidth, most vehicle drivers (perhaps excluding the premium automotive market niche) are reluctant to pay extra for vehicle telematics services, either in the form of an upfront payment (i.e., more expensive vehicle) or a recurring (monthly/yearly) service fee. Moreover, from the vehicle manufacturer's perspective, the services require additional hardware to be embedded into the vehicle, resulting in extra costs on the order of $250 to $350 or more per vehicle which cannot be recouped. Thus, manufacturers have been slow to fully commit to or invest in the provision of vehicle telematics equipment in all vehicles.

There have been rudimentary attempts in the past to determine when a smartphone is in a moving vehicle. Wireless service provider AT&T, Sprint and Verizon, for example, offer a smartphone application that reacts in a specific mariner to incoming text messages and voice calls when a phone is in what AT&T calls DriveMode™. With the AT&T DriveMode application, a wireless telephone is considered to be in “drive mode” when one of two conditions are met. First, the smartphone operator can manually turn on the application, i.e., she “tells” the application to enter drive mode. Alternatively, when the DriveMode application is in automatic on/off mode and the smartphone GPS sensor senses that the smartphone is travelling at greater than 25 miles per hour, the GPS sensor so informs the DriveMode application, the DriveMode application concludes that the smartphone is in a moving vehicle, and drive mode is entered.

Both of these paths to engaging the AT&T DriveMode application—the “manual” approach to entering drive mode and the “automatic” approach to entering drive mode—are problematic. First, if the smartphone operator forgets or simply chooses not to launch the DriveMode application prior to driving the vehicle when the application is in manual mode then the application will not launch. Second, in automatic on/off mode AT&T's use of only the GPS sensor to determine when a smartphone is in a moving vehicle is problematic for a number of reasons. First, the speed threshold of the application is arbitrary, meaning that drive mode will not be detected/engaged at less than 25 mph. If the vehicle is stopped in traffic or at a traffic signal, for example, then the DriveMode application may inadvertently terminate. Second, and perhaps more importantly, AT&T's DriveMode application requires that the smartphone's GPS functionality be turned on at all times. Because the use of a smartphone's GPS sensor is extremely demanding to the battery resources of a smartphone, this requirement severely undermines the usefulness of AT&T's application. Thirdly this method does not differentiate between the type of vehicle that the phone is in, e.g. a bus, a taxi or a train and therefore allows no correlation between the owner of the phone and her driving situation. For the classic embedded telematics devices to be replaces by smartphones it is important to correlate the driver and smartphone owner with her personal vehicle. Only then the smartphone can truly take the functional role of an embedded telematics device in a vehicle.

Accordingly, for at least the foregoing reasons there exists a need and it is an object of the present invention to provide an improved method and apparatus of determining the location of a smartphone so that a specific mode of operation may be activated.

### SUMMARY

The present invention provides an improved method and apparatus of determining the specific location of a smartphone such that a specific mode of operation may be enacted.

Various embodiments described herein are drawn to a device, for use with a database. The device includes a parameter-detecting component, an input component, an accessing component, a comparing component and an identifying component. The parameter-detecting component can detect a first parameter, can detect a second parameter and can generate a detected parameter signature, wherein the detected parameter signature is based on the first detected parameter and the second detected parameter. The input component can input the detected parameter signature into the database. The accessing component can access the detected parameter signature from the database. The comparing component can generate a comparison signal. The identifying component can identify a location based on the comparison signal. The parameter-detecting component can further detect a third parameter, can detect a fourth parameter and can generate a second detected parameter signature, wherein the second detected parameter signature is based on the third detected parameter and the fourth detected parameter. The comparing component can generate the comparison signal based on the detected parameter signature and the second detected parameter signature.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a person walking towards a vehicle;

FIG. 2 is a planar view of an interior of a vehicle;

FIG. 3 illustrates an example method of determining a location in accordance with aspects of the present invention;

FIG. 4 illustrates an example method of registering a signature associated with a location in accordance with aspects of the present invention;

FIG. 5 illustrates an example device for identifying a location in accordance with aspects of the present invention;

FIG. 6 illustrates an example parameter-detecting component in accordance with aspects of the present invention; and

FIG. 7 illustrates an example method of detecting a location in accordance with aspects of the present invention.

### DETAILED DESCRIPTION

Aspects of the present invention are drawn to a system and method for determining a specific location by utilizing field properties within and/or near the specific location.

As used herein, the term “smartphone” includes cellular and/or satellite radiotelephone(s) with or without a display (text/graphical); Personal Communications System (PCS) terminal(s) that may combine a radiotelephone with data processing, facsimile and/or data communications capabilities; Personal Digital Assistant(s) (PDA) or other devices that can include a radio frequency transceiver and a pager, Internet/Intranet access, Web browser, organizer, calendar and/or a global positioning system (GPS) receiver; and/or conventional laptop (notebook) and/or palmtop (netbook) computer(s), tablet(s), or other appliance(s), which include a radio frequency transceiver. As used herein, the term “smartphone” also includes any other radiating user device that may have time-varying or fixed geographic coordinates and/or may be portable, transportable, installed in a vehicle (aeronautical, maritime, or land-based) and/or situated and/or configured to operate locally and/or in a distributed fashion over one or more location(s).

In accordance with aspects of the present invention a location may be identified by a communication device, e.g., a smartphone. The location may be identified by detecting at least two parameters, generating a signature based on the detected parameters, and comparing the generated signature with another signature associated with a known location. Once the location is identified, the communication device may operate in a predetermined mode based on the location. In one non-limiting example embodiment, a smartphone may detect a magnetic field and another parameter to determine whether the smartphone is in a vehicle and then operate in a vehicle mode.

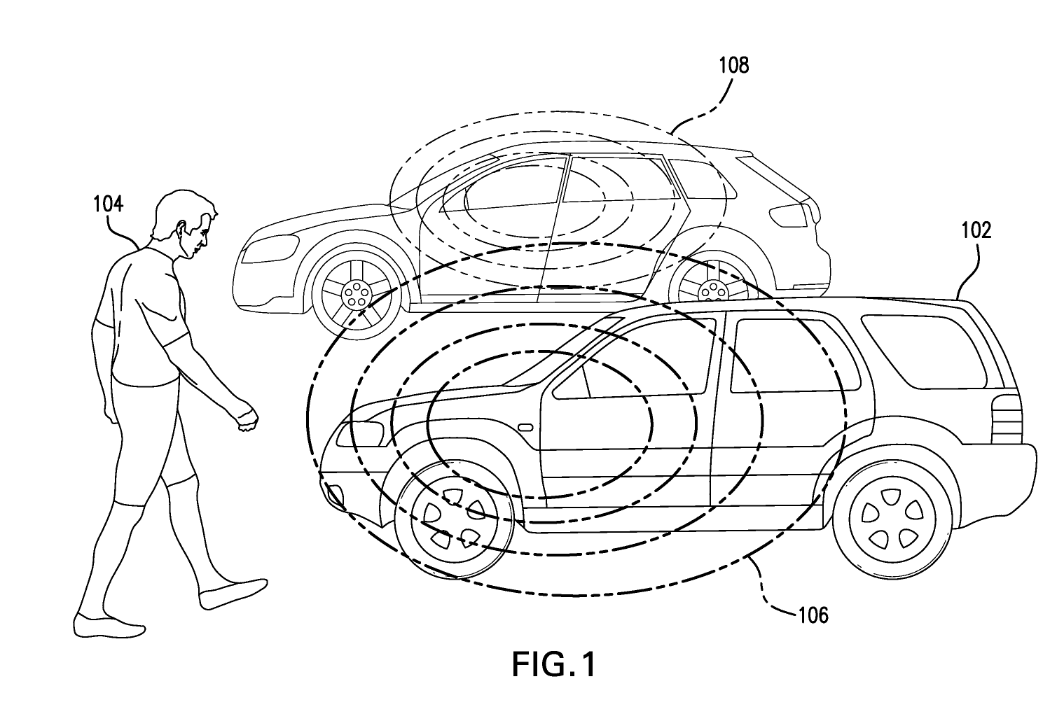

These aspects will now be described in more detail with reference to FIGS. 1-7.

FIG. 1 illustrates a person 104 walking towards a vehicle 102. A magnetic field 106 is located near vehicle 102 and ambient noise 108 is additionally present vehicle 102. In accordance with aspects of the present invention, parameters such as magnetic field 106 and ambient noise 108 may be detected by a device of person 104 in order to identify his location. The mode of operation of the device may be modified based on the detected location.

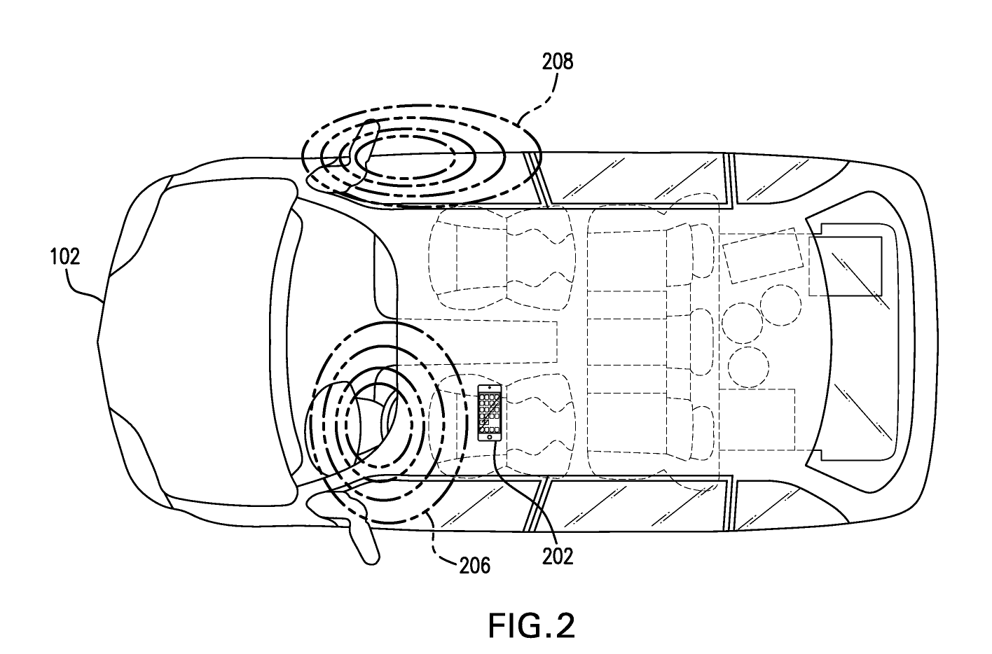

FIG. 2 is a planar view of an interior of vehicle 102. A position 202 represents the location of a smartphone within vehicle 102. A superposition of magnetic fields at position 202 is represented by field lines 206. A superposition of sound at position 202 is represented by lines 208. Again, in accordance with aspects of the present invention, parameters such as magnetic fields at position 202 and sound at position 202 may be detected by a device of person in order to identify his location—as being in a vehicle. The mode of operation of the device may be set to vehicle mode.

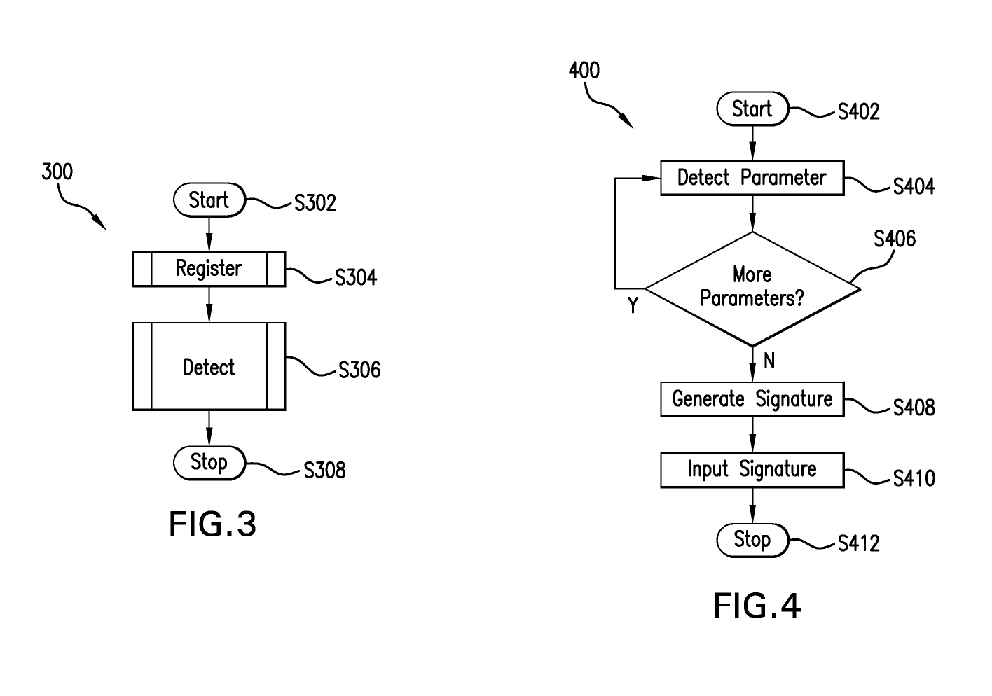

In some embodiment, first a location of the device is identified. Then, if the location has a specific mode associated therewith, the mode of the device may be changed to correspond to the identified location. This will be described in more detail with respect to FIGS. 3-7.

FIG. 3 illustrates an example method 300 of determining a location in accordance with aspects of the present invention.

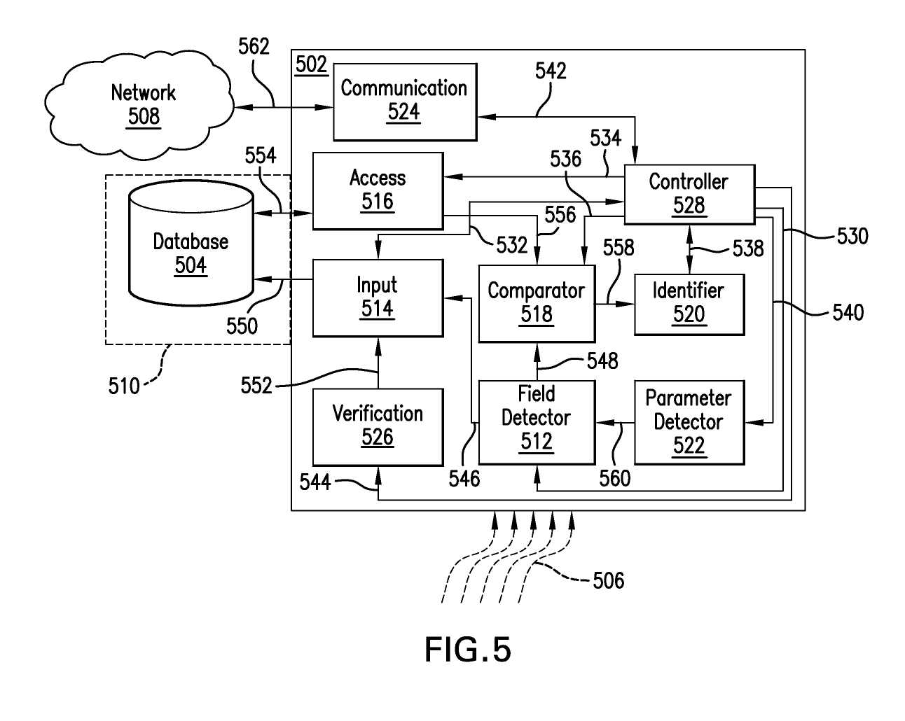

Method 300 starts (S302) and a location is registered (S304). FIG. 4 illustrates an example method 400 of registering a signature associated with a location in accordance with aspects of the present invention. For purposes of discussion, an example device will be described with additional reference to FIG. 5 to discuss method 400.

FIG. 5 illustrates an example device 502 in accordance with aspects of the present invention.

FIG. 5 includes a device 502, a database 504, a field 506 and a network 508. In this example embodiment, device 502 and database 504 are distinct elements. However, in some embodiments, device 502 and database 504 may be a unitary device as indicated by dotted line 510.

Device 502 includes a field-detecting component 512, an input component 514, an accessing component 516, a comparing component 518, an identifying component 520, a parameter-detecting component 522, a communication component 524, a verification component 526 and a controlling component 528.

In this example, field-detecting component 512, input component 514, accessing component 516, comparing component 518, identifying component 520, parameter-detecting component 522, communication component 524, verification component 526 and controlling component 528 are illustrated as individual devices. However, in some embodiments, at least two of field-detecting component 512, input component 514, accessing component 516, comparing component 518, identifying component 520, parameter-detecting component 522, communication component 524, verification component 526 and controlling component 528 may be combined as a unitary device. Further, in some embodiments, at least one of field-detecting component 512, input component 514, accessing component 516, comparing component 518, identifying component 520, parameter-detecting component 522, communication component 524, verification component 526 and controlling component 528 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Controlling component 528 is configured to communicate with: field-detecting component 512 via a communication line 530; input component 514 via a communication line 532; accessing component 516 via a communication line 534; comparing component 518 via a communication line 536; identifying component 520 via a communication line 538; parameter-detecting component 522 via a communication line 540; communication component 524 via a communication line 542; and verification component 526 via a communication line 544. Controlling component 528 is operable to control each of field-detecting component 512, input component 514, accessing component 516, comparing component 518, identifying component 520, parameter-detecting component 522, communication component 524 and verification component 526.

Field-detecting component 512 is additionally configured to detect field 506, to communicate with input component 514 via a communication line 546 and to communicate with comparing component 518 via a communication line 548. Field-detecting component 512 may be any known device or system that is operable to detect a field, non-limiting examples of which include an electric field, a magnetic field, and electro-magnetic field and combinations thereof. In some non-limiting example embodiments, field-detecting component 512 may detect an amplitude of a field at an instant of time. In some non-limiting example embodiments, field-detecting component 512 may detect a field vector at an instant of time. In some non-limiting example embodiments, field-detecting component 512 may detect an amplitude of a field as a function over a period of time. In some non-limiting example embodiments, field-detecting component 512 may detect a field vector as a function over a period of time. In some non-limiting example embodiments, field-detecting component 512 may detect a change in the amplitude of a field as a function over a period of time. In some non-limiting example embodiments, field-detecting component 512 may detect a change in a field vector as a function over a period of time. Field-detecting component 512 is additionally able to generate a field signal based on the detected field.

Input component 514 is additionally configured to communicate with database 504 via a communication line 550 and to communicate with verification component 526 via a communication line 552. Input component 514 may be any known device or system that is operable to input data into database 504. Non-limiting examples of input component 514 include a graphic user interface having a user interactive touch screen or keypad.

Accessing component 516 is additionally configured to communicate with database 504 via a communication line 554 and to communicate with comparing component 518 via a communication line 556. Accessing component 516 may be any known device or system that access data from database 504.

Comparing component 518 is additionally configured to communicate with identifying component 520 via a communication line 558. Comparing component 518 may be any known device or system that is operable to compare two inputs.

Parameter-detecting component 522 is additionally configured to communicate with field-detecting component 512 via a communication line 560. Parameter-detecting component 522 may be any known device or system that is operable to detect a parameter, non-limiting examples of which include velocity, acceleration, geodetic position, sound, temperature, vibrations, pressure, contents of surrounding atmosphere and combinations thereof. In some non-limiting example embodiments, parameter-detecting component 522 may detect an amplitude of a parameter at an instant of time. In some non-limiting example embodiments, parameter-detecting component 522 may detect a parameter vector at an instant of time. In some non-limiting example embodiments, parameter-detecting component 522 may detect an amplitude of a parameter as a function over a period of time. In some non-limiting example embodiments, parameter-detecting component 522 may detect a parameter vector as a function over a period of time. In some non-limiting example embodiments, parameter-detecting component 522 may detect a change in the amplitude of a parameter as a function over a period of time. In some non-limiting example embodiments, parameter-detecting component 522 may detect a change in a parameter vector as a function over a period of time.

Communication component 524 is additionally configured to communicate with network 508 via a communication line 562. Communication component 524 may be any known device or system that is operable to communicate with network 508. Non-limiting examples of communication component include a wired and a wireless transmitter/receiver.

Verification component 526 may be any known device or system that is operable to provide a request for verification. Non-limiting examples of verification component 526 include a graphic user interface having a user interactive touch screen or keypad.

Communication lines 530, 532, 534, 536, 538, 540, 542, 544, 544, 546, 548, 550, 552, 554, 556, 558, 560 and 562 may be any known wired or wireless communication path or media by which one component may communicate with another component.

Database 504 may be any known device or system that is operable to receive, store, organize and provide (upon a request) data, wherein the “database” refers to the data itself and supporting data structures. Non-limiting examples of database 504 include a memory hard-drive and a semiconductor memory.

Network 508 may be any known linkage of two or more communication devices. Non-limiting examples of database 508 include a wide-area network, a local-area network and the Internet.

Returning to FIG. 4, method 400 starts (S402) and a parameter is detected (S404). For example, returning to FIG. 5, let the parameter be a field, wherein field-detecting component 512 detects field 506. For purposes of discussion, let field 506 be a magnetic field corresponding to the magnetic fields generated by all electronic and mechanical systems involved with the vehicle while the device is near location 116, as discussed above with reference to FIG. 1. This is a non-limiting example, wherein the detected parameter may be any known detectable parameter, of which other non-limiting examples include electric fields, electro-magnetic fields, velocity, acceleration, angular velocity, angular acceleration, geodetic position, sound, temperature, vibrations, pressure, biometrics, contents of surrounding atmosphere, a change in electric fields, a change in electro-magnetic fields, a change in velocity, a change in acceleration, a change in angular velocity, a change in angular acceleration, a change in geodetic position, a change in sound, a change in temperature, a change in vibrations, a change in pressure, a change in biometrics, a change in contents of surrounding atmosphere and combinations thereof.

Returning to FIG. 4, after the first parameter is detected (S404), it is determined whether another parameter is to be detected (S406). For example, returning to FIG. 5, controlling component 528 may instruct at least one of field-detecting component 512 and parameter-detecting component 522 to detect another parameter.

A magnetic field may be a relatively distinct parameter that may be used to determine whether device 502 is in a specific location. However, there may be situations that elicit a false positive—e.g., a magnetic field th at erroneously indicates that device 502 is in a vehicle is actually associated with the operation of a vending machine that is not in the vehicle. As such, in order to reduce the probability of a false positive indication that device 502 is in a specific location, a second parameter associated with the location may be used. Along this notion, it is an example aspect of the invention to detect a plurality of parameters associated with a location to increase the probability of a correct identification of the location.

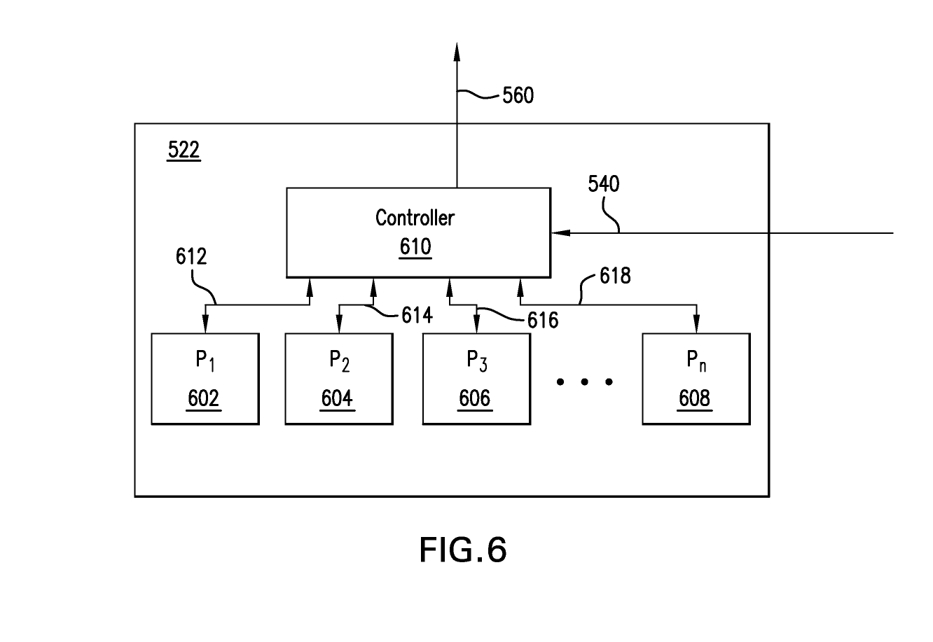

In some embodiments, device 502 has a predetermined number of parameters to detect, wherein controlling component 528 may control such detections. For example, the first parameter to be detected (in S404) may be a magnetic field associated with a running vehicle, wherein controlling component 528 may instruct field-detecting component 512 to detect a magnetic field. Further, a second parameter to be detected may be another known detected parameter additionally associated with the running vehicle, e.g., sound, wherein controlling component 528 may instruct parameter-detecting component 522 to detect the second parameter. Further parameter-detecting component 522 may be able to detect many parameters. This will be described with greater detail with reference to FIG. 6.

FIG. 6 illustrates an example parameter-detecting component 522.

As shown in the figure, parameter-detecting component 522 includes a plurality of detecting components, a sample of which are indicated as a first detecting component 602, a second detecting component 604, a third detecting component 606 and an n-th detecting component 608. Parameter-detecting component 522 additionally includes a controlling component 610.

In this example, detecting component 602, detecting component 604, detecting component 606, detecting component 608 and controlling component 610 are illustrated as individual devices. However, in some embodiments, at least two of detecting component 602, detecting component 604, detecting component 606, detecting component 608 and controlling component 610 may be combined as a unitary device. Further, in some embodiments, at least one of detecting component 602, detecting component 604, detecting component 606, detecting component 608 and controlling component 610 may be implemented as a computer having tangible computer-readable media for carrying or having computer-executable instructions or data structures stored thereon.

Controlling component 610 is configured to communicate with: detecting component 602 via a communication line 612; detecting component 604 via a communication line 614; detecting component 606 via a communication line 616; and detecting component 608 via a communication line 618. Controlling component 610 is operable to control each of detecting component 602, detecting component 604, detecting component 606 and detecting component 608. Controlling component 610 is additionally configured to communicate with controlling component 528 of FIG. 5 via communication line 540 and to communicate with field-detecting component 512 of FIG. 5 via communication line 560.

The detecting components may each be a known detecting component that is able to detect a known parameter. For example each detecting component may be a known type of detector that is able to detect at least one of electric fields, electro-magnetic fields, velocity, acceleration, angular velocity, angular acceleration, geodetic position, sound, temperature, vibrations, pressure, biometrics, contents of surrounding atmosphere, a change in electric fields, a change in electro-magnetic fields, a change in velocity, a change in acceleration, a change in angular velocity, a change in angular acceleration, a change in geodetic position, a change in sound, a change in temperature, a change in vibrations, a change in pressure, a change in biometrics, a change in contents of surrounding atmosphere and combinations thereof. For purposes of discussion, let: detecting component 602 be able to detect sound; detecting component 604 be able to detect velocity in three dimensions; detecting component 606 be able to detect vibrations; and detecting component 608 be able to detect geodetic position.

In some non-limiting example embodiments, at least one of the detecting components of parameter-detecting component 522 may detect a respective parameter as an amplitude at an instant of time. In some non-limiting example embodiments, at least one of the detecting components of parameter-detecting component 522 may detect a respective parameter as a function over a period of time.

Each of the detecting components of parameter-detecting component 522 is able to generate a respective detected signal based on the detected parameter. Each of these detected signals may be provided to controlling component 610 via a respective communication line.

Controlling component 610 is able to be controlled by controlling component 528 via communication line 540.

Returning to FIG. 4, if another parameter is to be detected (Y at S406), then another parameter will be detected (S404). For example, as shown in FIG. 5, controlling component 528 may then instruct parameter-detecting component 522 to detect another parameter via communication line 540. For purposes of discussion, let the second parameter to be detected be sound. As such, at this point, as shown in FIG. 6, controlling component 610 instructs detecting component 602, via communication line 612, to detect sound. Detecting component 602 provides a signal corresponding to the detected sound to controlling component 610 via communication line 612. In this example, controlling component 610 may then provide the detected signal to field-detecting component 512 via communication line 560 as shown in FIG. 5.

Returning to FIG. 4, if another parameter is to be detected (Y at S406), then another parameter will be detected (S404). For example, as shown in FIG. 5, controlling component 528 may then instruct parameter-detecting component 522 to detect another parameter via communication line 540. For purposes of discussion, let the second parameter to be detected be velocity in three dimensions. As such, at this point, as shown in FIG. 6, controlling component 610 instructs detecting component 604, via communication line 614, to detect velocity in three dimensions. Detecting component 604 provides a signal corresponding to the detected three dimensional velocity to controlling component 610 via communication line 614. In this example, controlling component 610 may then provide the detected signal to field-detecting component 512 via communication line 560 as shown in FIG. 5.

Returning to FIG. 4, if another parameter is to be detected (Y at S406), then another parameter will be detected (S404). This process will repeat until all the parameters to be detected are detected. In some embodiments, this process will repeat a predetermined number of times in order to detect predetermined types of parameters. In some embodiments, this process is only repeated until enough parameters are detected in order reach a predetermined probability threshold, which will reduce the probability of a false positive location identification.

Returning to FIG. 6, as just discussed, controlling component 610 is able to send individual detected signals from each detecting component. In other example embodiments, controlling component 610 is able to receive and hold the individual detected signals from each detecting component, wherein controlling component 610 is able to generate a composite detected signal that is based on the individual detected signals. The composite detected signal may be based on any of the individual detected signal, and combinations thereof. In some embodiments, controlling component 610 may additionally process any of the individual detected signals and combinations thereof to generate the composite detected signal. Non-limiting examples of further processes include averaging, adding, subtracting, and transforming any of the individual detected signals and combinations thereof.

It should be further noted that in some embodiments, all parameters that are to be detected are detected simultaneously. In such a case, for example, as shown in FIG. 5, controlling component 528 may then instruct parameter-detecting component 522 to detect all parameters via communication line 540. As such, at this point, as shown in FIG. 6, controlling component 610 instructs all the detecting components to detect their respective parameters. All the detecting components then provide a respective signal corresponding to the respective detected parameter to controlling component 610 via communication line 614. In this example, controlling component 610 may then provide the detected signal to field-detecting component 512 via communication line 560 as shown in FIG. 5.

Returning to FIG. 4, if no more parameters are to be detected (N at S406), then a signature is generated (S408). In some embodiments, for example as shown in FIG. 5, field-detecting component 512 may generate a signature of the location based on the field signal and the detected signal from parameter-detecting component 522. In some embodiments, field-detecting component 512 may additionally process any of the field signal and the detected signal from parameter-detecting component 522 to generate such a signature. Non-limiting examples of further processes include averaging, adding, subtracting, and transforming any of the field signal and the detected signal from parameter-detecting component 522. Therefore, the generated signature is based on the detected field and at least one detected parameter.

Returning to FIG. 4, once the signature is generated (S408), the signature in input into memory (S410). For example, as shown in FIG. 5, field-detecting component 512 provides the signature to input component 514 via communication line 546.

In an example embodiment, input component 514 includes a GUI that informs a user of device 502 that a signature has been generated. Input component 514 may additionally enable the user to input an association between the location and the generated signature. For example, input component 514 may display on a GUI a message such as “A signature was generated. To what location is the signature associated?” Input component 514 may then display an input prompt for the user to input, via the GUI, a location to be associated with the generated signature.

Input component 514 may then provide the signature, and the association to a specific location, to database 504 via communication line 550.

As discussed above, in some embodiments, database 504 is part of device 502, whereas in other embodiments, database 504 is separate from device 502. Data input and retrieval from database 504 may be faster when database 504 part of device 502, as opposed to cases where database 504 is distinct from device 502. However, size may be a concern when designing device 502, particularly when device 502 is intended to be a handheld device such as a smartphone. As such, device 502 may be much smaller when database 504 is distinct from device 502, as opposed to cases where database 504 is part of device 502.

Consider an example embodiment, where database 504 is part of device 502. In such cases, input component 514 may enable a user to input signatures and the location associations, for a predetermined number of locations. In this manner, database 504 will only be used for device 502.

Now consider an example embodiment, where database 504 is separate from device 502. Further, let database 504 be much larger than the case where database 504 is part of device 502. Still further, let database 504 be accessible to other devices in accordance with aspects of the present invention. In such cases, input component 514 may enable a user to input signatures and the item/location associations, for a much larger predetermined number of locations. Further, in such cases, input component 514 may enable other users of similar devices to input signatures and the location associations, for even more locations.

An example embodiment may use the differentiating magnetic field properties and other detected parameters associated with a vehicle to identify the vehicle. Today's vehicles are fully equipped with electronic and mechanical actuators and switches, engine subsystems. All these subsystems are generating their own electromagnetic and magnetic fields and therefore will alter the overall three-dimensional properties and field strength fluctuations of the vehicle interior, for example as discussed above with reference to lines 206 of FIG. 2. Further, particularly the ignition of a vehicle generates a characteristic magnetic flux for every vehicle. Additionally, many vehicles generate an identifying amount of road noise in the vehicle interior, for example as discussed above with reference to lines 208 of FIG. 2. Aspects of the present invention include generating a signature based on at least two of these detected parameters and storing these signatures within database 504 for a reference group of make and models. As such, any user of a device may be able to identify a registered vehicle within database 504. Thus, through previously stored signatures and additional measurements, the present invention enables a library of vehicular signatures. This library may be augmented with additional measurements describing the signatures of different vehicles.

It should be noted that although the above-discussed example includes identifying a vehicle as a location, this is a non-limiting example. Aspects of the invention may additionally be used to identify any location that has detectable parameters.

At this point, method 400 stops (S412).

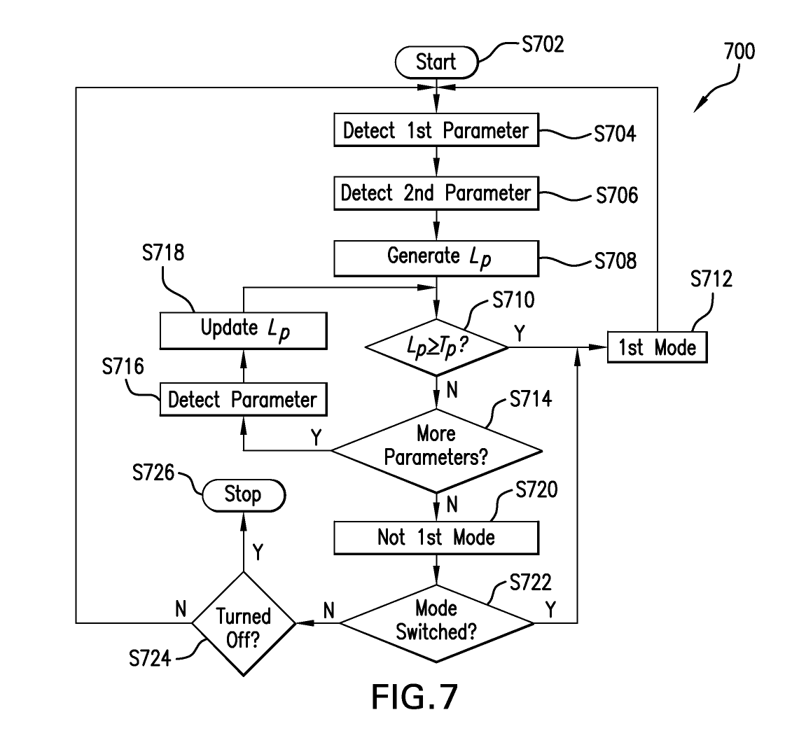

Returning to FIG. 3, now that a location is registered (S304), a new location may be detected (S306). An example method of detecting a new location will now be described with reference to FIG. 7.

FIG. 7 illustrates an example method 700 of detecting a location in accordance with aspects of the present invention. For purposes of discussion, let the location to be identified be a vehicle.

Method 700 starts (S702) and the first parameter is detected (S704). This is similar to the parameter-detecting (S404) of method 400 discussed above with reference to FIG. 4. For example, returning to FIG. 5, let the parameter be a field, wherein field-detecting component 512 detects field 506. For purposes of discussion, let field 506 be a magnetic field corresponding to the superposition of magnetic fields generated by all electronic and mechanical systems involved with the vehicle while the device is near location 116, as discussed above with reference to FIG. 1. Again, this is a non-limiting example, wherein the detected parameter may be any known detectable parameter, of which other non-limiting examples include electric fields, electro-magnetic fields, velocity, acceleration, angular velocity, angular acceleration, geodetic position, sound, temperature, vibrations, pressure, biometrics, contents of surrounding atmosphere, a change in electric fields, a change in electro-magnetic fields, a change in velocity, a change in acceleration, a change in angular velocity, a change in angular acceleration, a change in geodetic position, a change in sound, a change in temperature, a change in vibrations, a change in pressure, a change in biometrics, a change in contents of surrounding atmosphere and combinations thereof.

Returning to FIG. 7, after the first parameter is detected (S704), a second parameter is detected (S706). For example, returning to FIG. 5, controlling component 528 may instruct at least one of field-detecting component 512 and parameter-detecting component 522 to detect another parameter. This is similar to method 400 (S406) discussed above with reference to FIG. 4.

Returning to FIG. 7, after the first two parameters are detected (S704 and S706), a location probability, Lₚ, is generated (S708). For example, first a signature may be generated based on the two detected parameters. This signature may be generated in a manner similar to the manner discussed above in method 400 (S408) of FIG. 4. Controlling component 528 may then instruct access component 516 to retrieve the previously-stored signature, e.g., from method 400 of FIG. 4, from database 504 and to provide the previously-stored signature to comparing component 518.

Controlling component 528 may then instruct comparator to generate a location probability, Lₚ, indicating a probability that the new location as the previous location. In an example embodiment, the newly generated signature is compared with the previously-stored signature. If the newly generated signature is exactly the same as the previously-stored signature, then the generated location probability will be 1, thus indicating that the newly-detected location is the same as the previously-detected location. Variations between the newly generated signature and the previously-stored signature will decrease the generated location probability, thus decreasing the likelihood that the newly-detected location is the same as the previously-detected location. Any known method of comparing two signatures to generate such a probability may be used.

In an example embodiment, a comparison is made between similar parameter signals. For example, let a previously-stored signature be a function corresponding to a previously-detected magnetic field and a second function corresponding to a previously-detected sound, and let a newly-detected signature be a function corresponding to a newly-detected magnetic field and a second function corresponding to a newly-detected sound. The comparison would include a comparison of the function corresponding to the previously-detected magnetic field and the function corresponding to the newly-detected magnetic field and a comparison of the second function corresponding to a previously-detected sound and the second function corresponding to a newly-detected sound.

Controlling component 528 may then provide the location probability to identifying component 520 via communication line 558.

Returning to FIG. 7, it is then determined whether the generated location probability is greater than or equal to a predetermined probability threshold (S710). For example, identifying component 520 may have a predetermined probability threshold, Tₚ, stored therein. The probability threshold Tₚ may be established to take into account acceptable variations in detected parameters. For example, all vehicles may have varying unique magnetic signatures, thermal signatures, and acoustic signatures. However, when compared to the magnetic signatures, thermal signatures, and acoustic signatures of a public library, the magnetic signatures, thermal signatures, and acoustic signatures of all vehicles may be considered somewhat similar. These similarities may be taken into account when setting the probability threshold Tₚ.

Clearly, if the probability threshold Tₚ is set to one, this would only be met if newly generated signature is exactly the same as the previously-stored signature, thus indicating that the newly-detected location is the same as the previously-detected location. Further, this threshold would not be met if the sensors did not detect the exact parameters, which does not generally represent a real world scenario. On the contrary, if the probability threshold Tₚ is decreased, it would take into account variations in the detected parameters. Further, if the probability threshold Tₚ is decreased further, it may take into account variations in a class of locations, e.g., all vehicles.

In an example embodiment, identifying component 520 determines whether the location probability Lₚ generated by comparing component 518 is greater than or equal to the predetermined probability threshold Tₚ. In this case, identifying component 520 is a probability-assessing component that generates a probability of a specific mode based on a comparison or comparison signal.

Returning to FIG. 7, if it is determined that the generated location probability is greater than or equal to the predetermined probability threshold (Y at S710), then the device is operated in a first mode (S712). For example, consider the situation where a person carrying device 502 is driving in vehicle 102, that the signature for vehicle 102 has been previously stored, and that identifying component 520 has determined that the newly detected signature matches the previously stored signature for vehicle 102. In such a case, identifying component 520 instructs controlling component 528, via communication line 538, that device 502 should operate in a specific mode. For purposes of discussion, in this example, let the specific mode be a first mode, wherein the first mode is a vehicle mode. Further, for purposes of discussion, let the vehicle mode be such a mode wherein predetermined functions of device 502 may be disabled, such as texting.

It should be noted that aspects of the present invention may be used to establish operation of any type of mode of a device, wherein a specific mode may be associated with a specific location, and wherein the functionality of the device is altered in accordance with aspects of the specific location. For example, a “library mode” may alter the function of device 502 such that it is silent and only has a vibration alert.

Returning to FIG. 7, once the device is operated in the first mode (S712), the process repeats and the first parameter is again detected (S704).

If it is determined that the generated location probability is less than the predetermined probability threshold (N at S710), it is determine whether an additional parameter is to be detected (S714). For example, returning to FIG. 6, as discussed previously, parameter-detecting component 522 may be able to detect a plurality of parameters. In some embodiments, all parameters are detected at once, whereas in other embodiments some parameters are detected at different times.

Consider the situation where an initially generated location probability is based only on a newly-detected magnetic field as detected by field-detecting component 512 and on a newly-detected sound as detected by detecting component 602. Further, for purposes of discussion, let the generated location probability be less than the predetermined probability threshold. In such a case, if more parameters had been detected, they may be used to further identify the new location.

Returning to FIG. 7, if an additional parameter is to be detected (Y at S714), then an additional parameters is detected (S716). For example, controlling component 528 may instruct parameter-detecting component 522 to provide additional information based on additionally detected parameters to field-detecting component 512.

Returning to FIG. 7, after the additional parameter is detected (S716), the location probability is updated (S718). For example, the new signature may be generated in a manner similar to the manner discussed above in method 400 (S408) of FIG. 4. Controlling component 528 may then instruct access component 516 to retrieve the previously-stored signature, e.g., from method 400 of FIG. 4, from database 504 and to provide the previously-stored signature to comparing component 518.

Controlling component 528 may then instruct comparator to generate an updated location probability, Lₚᵤ, indicating a probability that the new location as the previous location. In an example embodiment, the newly generated signature is compared with the previously-stored signature. Again, any known method of comparing two signatures to generate such a probability may be used.

In an example embodiment, a comparison is made between similar parameter signals. For purposes of discussion, let the previously generated location probability Lₚ be based on the newly-detected magnetic field as detected by field-detecting component 512 and on a newly-detected sound as detected by detecting component 602. Now, let the updated, generated location probability Lₚᵤ be based on: 1) the newly-detected magnetic field as detected by field-detecting component 512; 2) the newly-detected sound as detected by detecting component 602; 3) a newly-detected velocity in three dimensions as detected by detecting component 604; 4) newly-detected vibrations as detected by detecting component 606; and 5) a newly-detected change in geodetic position as detected by detecting component 608.

The comparison would include a comparison of the function corresponding to the previously-detected magnetic field and the function corresponding to the newly-detected magnetic field and a comparison of the second function corresponding to a previously-detected sound and the second function corresponding to a newly-detected sound.

Returning to FIG. 7, after the location probability is updated (S718), it is again determined whether the generated location probability is greater than or equal to a predetermined probability threshold (S710). Continuing the example discussed above, now that many more parameters have been considered in the comparison, the updated location probability Lₚ, which is now Lₚᵤ, is greater than or equal to the probability threshold Tₚ. For example, although the previous comparison between only two parameters provided a relatively low probability, the additional parameters greatly increased the probability. For example, consider the situation where the detected magnetic field and the detected sound are sufficiently dissimilar to the previously stored magnetic field and sound associated with a previously stored location, e.g., a specific running vehicle. However, now that more parameters are considered, e.g., velocity, vibrations and change in geodetic position, it may be more likely that the current location is in fact the same as the previously stored location, e.g., a running vehicle.

Returning to FIG. 7, if an additional parameter is not to be detected (N at S714), then the device is not operated in the first mode (S716). For purposes of discussion, let the previously determined location be a vehicle and let device 502 be able to operate in a vehicle mode when in a vehicle, if the location probability Lp is ultimately lower than the predetermined probability threshold Tp, then the current location is determined to not be the same as the previously determined location. As such, device 502 would not be operating in the mode associated with the previously determined location. In this example therefore, device 502 would not be operating in a vehicle mode.

Returning to FIG. 7, it is then determined whether the current operating mode has been switched to the first mode (S722). For example, returning to FIG. 5, there may be situations where a user would like device 502 to operate in a specific mode, even though device 502 is not currently operating in such a mode. In those situations, user 502 may be able to manually change the operating mode of device 502. For example, the GUI of input component 514 may enable the user to instruct controlling component 528, via communication line 532, to operate in a specific mode.

Returning to FIG. 7, if it is determined that the current operating mode has been switched to the first mode (Y at S722), then the device is operated in a first mode (S712).

Alternatively, if it is determined that the mode has not been switched (N at S722), then it is determined whether the device has been turned off (S724). For example, returning to FIG. 5, there may be situations where a user turns off device 502 or device 502 runs out of power. If it is determined that the device has not been turned off (N at S724), the process repeats and the first parameter is again detected (S704). Alternatively, if it is determined that the device has been turned off (Y at S724), the method 700 stops (S726).

At this point, method 300 stops (S310).

The example embodiments discussed above are drawn to identifying a location using fields associated therewith. Once identified, other functions may be available. For example, consider the situation wherein a device in accordance with aspects of the present invention is embodied in a smartphone. In such an example, once a location (e.g., a vehicle, a house, an office building, etc.) is identified, the smartphone may institute a suite of applications and turn off other applications. In a specific example embodiment, the identification of a vehicle may be used to place a smartphone in a “Vehicle Mode,” wherein the smartphone will operate in a particular manner because it is determined to be in a vehicle.

In accordance with aspects of the present invention discussed above, the sensors and functionalities of smartphones can be used to supplement or even replace the known vehicle-based techniques of vehicle telematics. More specifically, smartphone-to-smartphone (when both phones are in Vehicle Mode), smartphone-to-infrastructure and infrastructure-to-smartphone communications (again, when the smartphone is in Vehicle Mode) can provide drivers with a wide range of telematics services and features, while resulting in little or no additional cost to the vehicle driver (because she likely already has a smartphone) or the vehicle manufacturer (because it doesn't have to provide the purchaser of the vehicle with a smartphone and also doesn't have to embed costly vehicle telematics equipment in the vehicle). To be able to do so, however, the smartphone again has to be able to “know” that it is in Vehicle Mode and be able to determine in what vehicle it is. Ideally for various applications it is necessary to be able to determine if the smartphone is in the vehicle that is owned by the smartphone user. Aspects of the present invention enable a smartphone to know that it is in Vehicle Mode based on detected magnetic, electric, magneto-electric fields and combinations thereof.

Further in accordance with the present invention, a smartphone may utilize its magnetometer function to periodically measure the electromagnetic levels sensed at the smartphone's current location. The smartphone uses its processing capabilities to try to map the periodic electromagnetic levels sensed by the smartphone with the vehicular electromagnetic signatures stored in library. If the periodic electromagnetic levels sensed by the smartphone match any of the specific vehicle signatures stored in the library, then the processor of the smartphone may generate and/or otherwise output a signal indicating that the smartphone is located in the specific vehicle, which in turn will be used by the Vehicle Mode detection method to trigger certain functions.

The Vehicle Mode relevant sensor suite may be monitored at intervals depending on detected speed and location, for example, up to several times per second. The magneto metric sensor output may be monitored dependent on the accelerometer output as this will indicate a movement of the phone either within the vehicle environment or of the vehicle itself.

In the drawings and specification, there have been disclosed embodiments of the invention and, although specific terms are employed, they are used in a generic and descriptive sense only and not for purposes of limitation, the scope of the invention being set forth in the following claims.

What is claimed as new and desired to be protected by Letters Patent of the United States is:

1. A device, for use with a database having a detected parameter signature stored therein, the detected parameter signature being based on a first parameter and a second parameter, said device comprising:
an accessing component operable to access the detected parameter signature from the database;
a parameter-detecting component operable to detect a third parameter, to detect a fourth parameter and to generate a second detected parameter signature based on the third detected parameter and the fourth detected parameter;
a comparing component operable to generate a comparison signal; and
an identifying component operable to identify a location based on the comparison signal,
wherein said comparison component is operable to generate the comparison signal based on a comparison of the detected parameter signature and the second detected parameter signature.

2. The device of claim 1, wherein said parameter-detecting component is operable to detect the third parameter as a function over a period of time.

3. The device of claim 1, wherein said parameter-detecting component is operable to detect, as the third parameter, one of the group consisting of a geodetic location, sound, time, acceleration, velocity, temperature and combinations thereof.

4. The device of claim 1, further comprising a communication component operable to wirelessly communicate with a network.

5. The device of claim 1, further comprising:
a probability-assessing component operable to generate a probability of a vehicle mode based on the comparison signal,
wherein said parameter-detecting component is further operable to detect a fifth parameter when the generated probability is greater than a predetermined amount.

6. A method for use with a database having a detected parameter signature stored therein, the detected parameter signature being based on a first parameter and a second parameter, said method comprising:
accessing, via an accessing component, the detected parameter signature from the database;
detecting, via a parameter-detecting component, a third parameter;
detecting, via the parameter-detecting component, a fourth parameter;
generating, via the parameter-detecting component, a second detected parameter signature based on the third detected parameter and the fourth detected parameter;
generating, via a comparing component, a comparison signal based on a comparison of the detected parameter signature and the second detected parameter signature; and
identifying, via an identifying component, a location based on the comparison signal.

7. The method of claim 6, wherein said detecting a third parameter comprises detecting the third parameter as a function over a period of time.

8. The method of claim 6, wherein said detecting a third parameter comprises detecting, as the third parameter, one of the group consisting of a geodetic location, sound, time, acceleration, velocity, temperature and combinations thereof.

9. The method of claim 6, further comprising wirelessly communicating, via a communication component, with a network.

10. The method of claim 6, further comprising:
generating, via a probability-assessing component, a probability of a vehicle mode based on the comparison signal, and
detecting, via the parameter-detecting component, a fifth parameter when the generated probability is greater than a predetermined amount.

11. A non-transitory, tangible, computer-readable media having computer-readable instructions stored thereon, use with a database having a detected parameter signature stored therein, the detected parameter signature being based on a first parameter and a second parameter, the computer-readable instructions being capable of being read by a computer and being capable of instructing the computer to perform the method comprising:
accessing, via an accessing component, the detected parameter signature from the database;
detecting, via a parameter-detecting component, a third parameter;
detecting, via the parameter-detecting component, a fourth parameter;
generating, via the parameter-detecting component, a second detected parameter signature based on the third detected parameter and the fourth detected parameter;
generating, via a comparing component, a comparison signal based on a comparison of the detected parameter signature and the second detected parameter signature; and
identifying, via an identifying component, a location based on the comparison signal.

12. The non-transitory, tangible, computer-readable media of claim 11, wherein the computer-readable instructions are capable of instructing the computer to perform the method such that wherein said detecting a third parameter comprises detecting the third parameter as a function over a period of time.

13. The non-transitory, tangible, computer-readable media of claim 11, the computer-readable instructions being capable of being read by a computer and being capable of instructing the computer to perform the method such that said detecting a third parameter comprises detecting, as the third parameter, one of the group consisting of a geodetic location, sound, time, acceleration, velocity, temperature and combinations thereof.

14. The non-transitory, tangible, computer-readable media of claim 11, wherein the computer-readable instructions are capable of instructing the computer to perform the method further comprising wirelessly communicating, via a communication component, with a network.

15. The non-transitory, tangible, computer-readable media of claim 11, the computer-readable instructions being capable of being read by a computer and being capable of instructing the computer to perform the method further comprising:
generating, via a probability-assessing component, a probability of a vehicle mode based on the comparison signal, and
detecting, via the parameter-detecting component, a fifth parameter when the generated probability is greater than a predetermined amount.
